(19) United States
(12) Patent Application Publication
(10) Pub. No.: US 2009/0106558 A1
(43) Pub. Date: Apr. 23, 2009

(54) System and Method for Adding Biometric Functionality to an Application and Controlling and Managing Passwords

(76) Inventors: David Delgrosso, Naperville, IL (US); Fraser Orr, Naperville, IL (US); Jason Shaver, Bolingbrook, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/123,847

(22) Filed: May 20, 2008

Related U.S. Application Data
(63) Continuation-in-part of application No. 11/512,444, filed on Aug. 30, 2006.
Application No. 11/512,444 is a division of application No. 11/051,259, filed on Feb. 4, 2005.
(60) Provisional application No. 60/541,966, filed on Feb. 5, 2004.

(51) Int. Cl. G06K 9/00; H04K 1/00; H04L 9/32

(52) U.S. Cl. 713/184; 713/186

(57) ABSTRACT

A system and method for adding biometric functionality to an application, and for controlling and managing passwords. The system and method include monitoring an application and providing a template matching a logon window of the application. The template obtains a biometric identifier of the user and inserts logon information into the window obtained from a database of user information.

### CROSS-REFERENCE TO RELATED APPLICATIONS

This application is a continuation-in-part application of U.S. patent application Ser. No. 11/512,444, filed Aug. 30, 2006, which is a Divisional Application of U.S. patent application Ser. No. 11/051,259, filed Feb. 4, 2005, which claims priority from U.S. Provisional Patent Application No. 60/541,966, filed Feb. 5, 2004. This application is also related to U.S. patent application Ser. No. 10/932,979 filed Sep. 2, 2004. The contents of these applications are incorporated herein by reference.

### FEDERALLY SPONSORED RESEARCH OR DEVELOPMENT

Not Applicable.

### TECHNICAL FIELD

The invention generally relates to a system and method for providing biometric security functionality to a system or application originally lacking such functionality and automating insertion of logon information, and for controlling and managing passwords for use with one or more systems or applications requiring password protection.

### BACKGROUND OF THE INVENTION

Many electronic systems and related software applications require some form of security to implement certain functionality of the system or application. For example, an Automatic Teller Machine (or ATM) typically requires a card with a magnetic strip containing account identification data and a Personal Identification Number (i.e., PIN) in order to provide a user access to the user's account. Other applications, such as an online banking website, may require entering of a user name and a private password into a logon window. In some instances, applications will implement additional security measures, such as requiring a user to respond to various personal questions. Typical questions may require, for example, the user to enter his or her mother's maiden name, or the user's city of birth.

As consumers become more aware—and fearful—of the growing danger of identity theft, they are also becoming increasingly frustrated with having to remember the growing number of account numbers, user names, passwords, PINs, access codes and other similar information designed to keep their identity secure. Moreover, as noted in the example given above, in addition to being required to remember this information, the consumers are also required in some instances to carry around cards (e.g., bank cards, proximity cards, badge swipes, etc.) as a further security measure.

Regardless of the user's frustrations, existing security policies in many regulated businesses require having strong passwords, as well as changing such passwords at frequent intervals. Specifically, system security policies have imposed Byzantine and onerous burdens on employees with regards to changing and formatting of passwords. For example, the following are common requirements: changing the password every 30 days; prohibiting passwords from being English words; requiring passwords to contain both upper and lower case letters, or one or more numerals or punctuation characters; requiring the password to be within specific length parameters; prohibiting repetition of a password, etc.

The burdens imposed by the security policies mean that password management is very difficult for users. The difficulty increases exponentially as more and more passwords are required to be remembered, and is further compounded because different applications often impose a different set of requirements on the password.

Often users need to remember half a dozen passwords at work, as well as their own personal passwords. The result of this unrealistic demand is that users often do everything in their power to undermine the security system. This includes writing their passwords down and sticking them to their monitors (or “securely” under their keyboards or other locations near the computer). Additionally, users will store the passwords in text files; write them on the whiteboard, etc. They also frequently use the same password on multiple systems when they are able to, or make minor changes to their passwords with each required change.

The problem is that the onerous requirements force users to fight against the security system rather than comport with it. As suggested above, this is a huge issue in highly regulated industries like banking, finance, healthcare, personal data protection, etc. As a result, the user's hostility to the security system compromises it.

Additionally, the numerous password requirements also creates a need for a support infrastructure in place to reset passwords that have been forgotten. This latter activity can cost a company on the order of $250 per password reset.

While the measures employed to date involve some level of security, they are not fool proof. Accordingly, a need exists for providing additional security for various systems and applications without causing the user to fight the system.

Often users would like to add biometric capabilities for logging on to their applications, however, that capability is not typically offered by the application vendor. In the past, integrating biometrics into a software system was costly and time consuming.

The present invention is provided to solve the problems discussed and to provide advantages and aspects not provided by prior systems or methods. A full discussion of the features and advantages of the present invention is deferred to the following detailed description, which proceeds with reference to the accompanying drawings.

### SUMMARY OF INVENTION

The present invention provides a system and method that adds biometric capability to an existing electronic system (e.g., a computer or network of computers, ATM etc.) and/or application (i.e., a program or group of programs designed for end-users—in the context of the present invention “application” should be construed to include both Web pages and desktop applications) run on the system without requiring changes to the application. In accordance with one embodiment, the present system and method accomplishes this by implementing a biometric database in a central application which can be injected into the appropriate controls of the non-biometric application. This causes the original (non-biometric) application to behave, from the user's perspective, as a biometric application. Moreover, the present invention can be incorporated into existing computer systems quickly and with negligible integration costs.

Additionally, the present invention provides a system and method for automating the generation and management of passwords required by an application. This allows for use of strong passwords that can be changed frequently without requiring the user to remember the password.

In accordance with one aspect of the invention, the system and method utilize a biometric identifier of a user (e.g., fingerprint, iris scan, etc.) obtained through a biometric device (e.g., fingerprint reader, eye scanner, etc.). Using the biometric identifier, the system or method identifies the user and determines what password should be used for a particular application. The passwords can be stored in encrypted form in a central database and be associated with one or more biometric identifier of the user. Additional information about the user can also be stored in the database and utilized in connection with logging onto an application. The stored identifier(s) and related user information (e.g., both personal information of the user—name, address, social security number, account number, etc., and logon information—username, password, security questions/answers, etc.) can be obtained during an enrollment process, for example, when the user opens an account with a bank or financial institution, or becomes an employee thereof.

One goal of an aspect of the present system is to allow a System Administrator of an institution (at his or her discretion) the use of a password system in an application where the user never actually knows what their password is, and instead, simply relies on a biometric identifier. In addition to the benefit of simplifying a user's life, having the users not know passwords offers two additional benefits. First, passwords can easily be shared between multiple people, and changing the password reflects that change for everyone. Second, since the user does not know the password, they can be excluded very easily from the system by eliminating their access to the password.

In accordance with an embodiment of the invention, the present system includes a method for adding biometric identification security to an application that lacks such functionality. The method comprises running a first application lacking biometric identification from a computer coupled to a biometric device (e.g., a fingerprint scanner) by a user. A template is provided configured to monitor the first application. The method includes recognizing a logon screen of the first application by the template where the logon screen includes at least one field requiring insertion of user information, and prompting the user to input a biometric identifier using the biometric device. Additionally, the method includes comparing the inputted biometric identifier with a plurality of biometric identifiers maintained in a database of users authorized to access the first application. The database also includes logon information for the authorized users, such as a logon name, password and other user credentials. The method further includes matching the inputted biometric identifier of the user with one of the plurality of biometric identifiers in the database and, inserting the logon information of the user from the database into the at least one field of the logon screen using the template. This can include inserting the username, password, and/or other credentials depending on the logon requirements of the first application.

The insertion of user information can be accomplished in a variety of ways. According to one aspect the invention, the step of inserting the logon information of the user from the database using the template comprises simulating typing the logon information to the application by sending a sequence of keystrokes.

Also, the template can recognize the logon window using a variety of methodologies. In this regard, the step of recognizing a logon screen of the first application by the template comprises the step of matching a name of a logon window appearing in the application. In another alternative, the step of recognizing a logon screen of the first application by the template comprises the step of matching a logon field appearing in the application.

In accordance with one aspect of the invention, the application is accessible as a website over the Internet. In this case, the step of recognizing a logon screen of the first application by the template can comprise matching an uniform resource locator (i.e., URL) address of the logon screen of the application.

In another aspect of the invention, the template can be used to change the user's password. In this instance, the method can include the steps of requiring the user to change the user's password by the first application and, obtaining a new password for the user utilizing the template. This may include prompting the user for a new password and importing a new password received from the user into the database by the template, or the template automatically generating a new password associated with the user, and importing the new password into the database. The application may provide criteria for a new password. In which case, the method includes configuring the template to meet the application required criteria when generating a new password.

In accordance with another aspect of the invention, a system including additional biometric identification security for granting a user access to an application lacking biometric identification capability is provided. The system comprises a server configured to run a first application lacking biometric identification capability. The server is further configured to run a template configured to monitor the first application and obtain a biometric identifier of a user upon identifying a window in the first application requiring the insertion of logon information. The template is in communication with a database of biometric identifiers of a plurality of authorized users of the application. The database includes logon information for each authorized user. The template is also configured to insert logon information of the user into the logon window upon matching the user's biometric identifier with one of the biometric identifiers stored in the database. Additionally, the system includes a biometric device (such as a fingerprint scanner) coupled to the server for obtaining the biometric identifier of the user.

The template can be configured to utilize a matching methodology to determine when the first application is displaying the window requiring insertion of logon information. The methodology can match a name of the window requiring insertion of logon information, or match a field of the window requiring insertion of logon information.

The template is configured to input the user's password in the window requiring insertion of logon information. The template can also be configured to change the user's password to meet a requirement of the application, and associate the changed password with the user's logon information stored in the database.

Other features and advantages of the invention will be apparent from the following specification taken in conjunction with the following drawings.

### BRIEF DESCRIPTION OF THE DRAWINGS AND ATTACHMENTS

To understand the present invention, it will now be described by way of example, with reference to the accompanying drawings in which:

FIG. 1 is a flow chart illustrating the general operation of the present system and method;

FIG. 2 is a flow chart illustrating the operation of an aspect of the present system and method with respect to logging onto a banking application;

FIG. 3 is a flow chart illustrating the operation of an aspect of the present system and method with respect to entering an account number in a banking application;

FIG. 4 is a flow chart illustrating the operation of an aspect of the present system and method with respect to changing a password in a banking application;

FIG. 5 is a diagram illustrating components of a device for use with the present invention; and,

FIG. 6 is a diagram of the system installed on a plurality of personal computers connected to a central server.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is a system and method that adds a layer of biometric security to standard applications (i.e., applications that do not already require such security). The system and method also manage and control the use of passwords that may be required by the application based on the biometric identity of the user, allowing for use of one or more strong passwords that can be changed often without requiring the user to memorize or otherwise have knowledge of the password(s). Additionally, the system can be used to insert user credential information into the application based on the biometric identity of the user.

The present system and method integrate with an existing application by monitoring what is happening on the user's computer during the application and providing a template created for submitting data to the application. When the system notices a type of screen that traditionally requires secured data input, (e.g., a log-on screen), it prompts the user for biometric identification. Once the user is identified, the system finds the data fields, (e.g., password, user name, etc.), in a database associated with the template, and “types” or otherwise inputs the data directly into the appropriate fields of the application window.

Generally, a template is a processing element that can be combined with a data model and processed with by a template engine to produce a result document. In this regard, a template is a description of how to match an application window, and, when a match occurs, what to do to insert the data into the application. The template also includes data about what type of user authentication is required to run the template. Templates attempt to operate at abstract a level as possible, being as nonspecific as is possible, (while still distinguishing between candidate and peripheral applications). This allows templates to be fairly robust to application changes. Accordingly, if a web site (i.e., one type of application) has a face lift, it will not necessarily break a template. However, if a change to an application does break a template, a System Administrator can quickly change the template (because the template is preferably specified once at the enterprise), and the correction becomes immediately available to everyone in the enterprise.

Templates can be enterprise wide. Moreover, enterprises may utilize several templates for a variety of applications. The present system's templates can normalize software applications to use the same user name and password (or other logon data) by maintaining such information in a common database location accessible by the template for each application. This allows the same username and password (or other data) to be used in multiple applications. An organization might have multiple applications for different purposes, or might have several variations of an application for the same purpose. Templates normalize these applications, one or more template per application, to allow easy control of credentials and other user data. For example, a user with two or more e-mail accounts, each requiring a particular username format, can utilize the same password for each. In this regard, the template for each account would use the same template data stored in the database to obtain the password for each account. Alternatively, in accordance with one basic method, different user applications can have different templates and different data associated with them. If the user runs a number of distinct applications, separate templates can be created, each with its own logon credentials.

It is also possible for two or more applications to share credentials. This is particularly important in password change scenarios (i.e., an application that requires a password to periodically change). If two applications share a password in a background database, changing the password in one application may change it in the other. So sharing this password between templates in the present system allows this automatic synchronization.

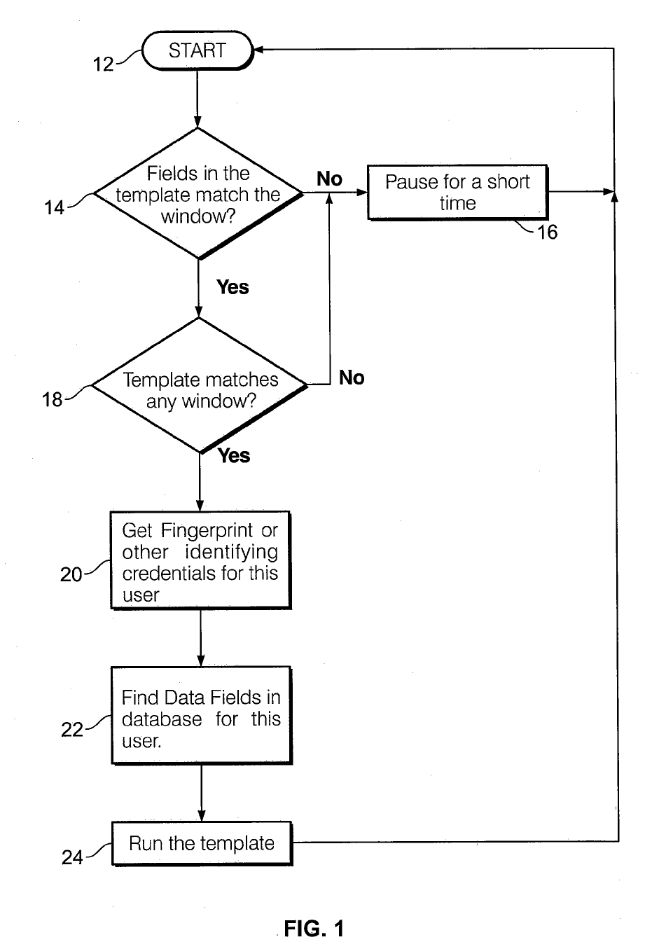

FIG. 1 illustrates the basic operation of the system and method utilizing a template. As an initial step 12, a user opens or otherwise starts an application that does not (by itself) require biometric identification. The system then determines if a template matches any window in the application (e.g., a log-on screen or window) 14. If the template does not match a window, the system pauses 16 and then loops back to watching the application 12. If the template matches a window, the system determines if the fields in the template match the window 18. If the fields do not match, the system again pauses 16 and loops back to the start 12. If the fields match, the system requests and obtains a biometric identifier (e.g., a fingerprint from a fingerprint scanner connected the user's computer) and/or other user identifying credentials or information 20. The system then locates data fields in a database associated with the user and the template 22, and then proceeds to run the template 24. At this point, the template inserts the identified user's information (e.g., password and other logon credentials) obtained from the database in the appropriate data fields in the appropriate locations in the application window and returns to the start 12.

Determining if the system has a template to run against an application is a two step process. First, the system determines if the application window meets three Windows' style requirements—that is, the window must be visible, it must have a caption property and it must have a border. Second, the system then matches the template against other Window's property and fields—for example, the window's executable name, the number of controls in the window, the window application form title, the window parent form title, and possibly other properties and fields.

The system can use a variety of methods for detecting when an application is waiting for data entry (such as entry of user names, passwords, etc.) and needs a template run. That is, the system can use one or more of several methodologies for matching a template to an application window.

For example, a ‘title match’ methodology can be employed. In this case, the match occurs when a window with the specified title first appears. This is a common scenario, for example, when a window titled “Log On” appears.

Another methodology is a ‘field match.’ In this case, a match occurs when a window with a particular configuration of controls appears. For example, a match occurs when a window with a regular text box and a password text box appears. In this case, the application is probably waiting for a username and password to be entered. This applies both to regular windows and to Web pages.

A ‘URL match’ can also be utilized. If the window is a Web page in various different categories of browser, a match takes place when the URL is equal to a specified URL, provided by the template. This will occur as a web page is navigated to for the first time, or if applicable, the tab of the web browser containing the URL is reactivated.

An ‘underlying URL match’ methodology can also be utilized. In this instance, a window associated with a Web page, (e.g., a Web page log on pop up window), has a URL associated with the underlying window. If the underlying URL matches the template URL, a match occurs.

The system can also utilize an ‘underlying window title match.’ Like the standard title match, if the window underlying the pop up window matches, then a match occurs.

Another alternative methodology is a “label contains strings match.’ In this case, the labels in the system are searched for a match with a string (directly or by regular expression). For example, if a decrypt password window contains the title of a file, this can be used to select the appropriate decryption password.

Another alternative is an ‘OCR text contains strings match.’ This is similar to the label contains strings matching method except that the text on the dialog first must be converted from an image to a text using an OCR engine. Once the conversion is completed, the match takes place.

Yet another alternative is a ‘partial expression match.’ In this case, applied to all title and URL matches, the match takes place using an expression where part of the expression matches the title or URL. For example, where the title or URL begins with, ends with or contains the string specified as the match expression.

Similarly, a ‘regular expression match’ can be utilized. In this case, applied to all title and URL matches, the match takes place using a regular expression, or some special category of regular expression. This is a set of rules that describes a similarity. For example, one might specify that the title begins with a particular piece of text, or that it ends with a particular text, or that it contains a particular text. Also, full regular expression matching is possible.

The system can also use a ‘dynamic code match.’ In this instance, the system provides a framework in which a small piece of program code is called to determine if the window matches.

The system can also use an ‘image match.’ In this case, the system provides an image and compares it to the new window. If it is sufficiently similar, then a match occurs. The system can allow the user to specify areas of the image to ignore, (e.g., if the window displays the date and time, which will obviously be different each time), and the degree of similarity.

Another alternative is a ‘regular retry match.’ Normally matching takes place when a window first appears. With regular retry, the system will retry the match at regular (e.g., preset or user specified) intervals to determine if the window has changed and a match can now take place. The template specifies both the frequency of retries and the maximum number of times to retry.

In yet another alternative, the system can use a ‘hotkey match.’ In this case, the template will designate a particular hot key, (e.g., Alt+F8 or Ctrl+Shift+A). When this hotkey is detected, then the template executes immediately. Note that hotkey matching can be combined with any of the other matching methods. So one hotkey can invoke different templates, depending on which additional matching criteria are specified.

Another match methodology is a ‘reactivation match.’ In this case, any matching the template specifies will occur again as a window is reactivated, even if it has already been evaluated. Note that reactivation matching can also be combined with any of the other matching methods.

Alternatively, an ‘automatic execution match’ can be used. By default, a template will automatically be examined to see if it is a match against a given window. The automatic execution match also provides a way to prevent the default operation from occurring. This is particularly useful when combined with the Hotkey matching. For example, if a system is configured to have a plurality of templates that are all activated by a particular hot key (e.g., “F12”), then it may be advantageous to turn off the automatic execution match to prevent such templates from running when a matching screen appears. In this example, if matching is required, hitting the F12 hot key will cause the template(s) that match to execute.

Also, a combination match can be implemented. This methodology includes utilizing any combination of the above matching methods to obtain a match (where each must match to make a match). The system can automatically make the comparisons in the optimal order.

Once the system identifies a window in an application that requires data entry, a field fill-in mechanism takes place. There are multiple methods that can be used to fill in the fields as described herein.

In a “Regular Field” method, the window controls (or the Web pages) are recognized as specified by the template and the appropriate data is copied into the field. The system uses various methods to ensure that each field is filled in correctly (since the dynamic behavior of some applications makes this difficult). The system can copy data directly into the field's appropriate property. Alternatively, the system can simulate a user typing the data by sending a sequence of keystrokes to the application field. This can be done with a set delay so that the keystrokes are slowly submitted to the application window. Additionally, the system can first select the data already in the field prior to simulating typing other data. The system can be configured to double check the result by reading the field property and comparing against the result. Alternatively, the system can be configured to double check the result by reading an image of the field as displayed and OCR (optical character recognition) converting the result for comparison (this needs to adequately compensate for any obscuring of the field).

Another method is identified as a “Copy Me Template.” In this method, a sequence of commands is played, such as selecting fields, clicking at locations, typing text or data fields, etc. The commands available are: text input (a stream of text that should be entered); control key sequence (a special key, such as pressing the Tab or Enter key would be simulated); focus change (the control of a window that should receive the active focus); field input (the data that should be injected should originate from the system's data storage, and should be unique to the user and directly tied to the user's biometric identifier); stream input (the ability to input text directly in a stream of outgoing data—this is particularly useful for inputting data in to terminal and Main Frame applications); delay (an amount of time to wait for proceeding); mouse event (the actions of a mouse that are to be replicated—these could include a mouse button being clicked or held down, and any mouse movements, and will denote the appropriate coordinates of any mouse actions); custom code (an external, third party program, having a predefined protocol, to be executed where the external program would have to adhere to the system's guidelines and requirements); variable assignment (the ability to create a temporary variable of data obtained from either the window the template is executing against or from direct user input—as is the case in a Password Change template); variable input (similar to the text input command, however the data being entered will originate from a temporary variable the script has created); variable storage (the ability to save the variable in the system's data repository); variable manipulation (the ability to manipulate a variable, such as summing variables together, or concatenating variables); variable checking (the ability to perform simple comparisons on variables—the results of any comparisons may be stored in new variables); and conditional script item blocks—begin/end (when used with the variable checking command, these two script items—a begin and an end—will comprise a sequence of commands to execute).

Copy Me templates can be either simple or advanced. The only difference is the presentation to the user. Simple Copy Me templates show only a limited number of commands in the template and present them in an easy to use way. The simple Copy Me template uses the following commands: text input (a stream of text that should be entered); control key sequences (a special key, such as pressing the Tab or Enter key would be simulated); field input (the data that should be injected should originate from system's data storage, and should be unique to the user and directly tied to the user's biometric identifier) and stream input (the ability to input text directly in a stream of outgoing data—this is particularly useful for inputting data in to terminal and Main Frame applications).

Another method is “Dynamic Coding.” The system provides a framework to enable the user to write a small piece of computer code to allow the user complete control over the template's behavior. This type of template is in fact a command in the Copy Me template.

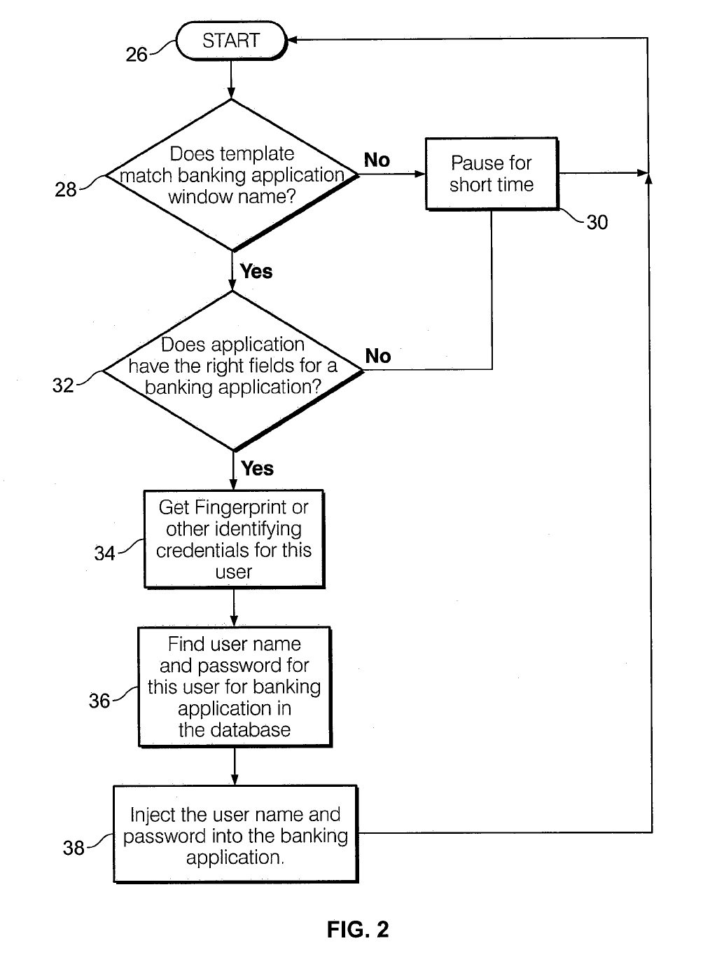

The result of using the methods described is that a logon field, or other data field in a logon window of an application can be filled in automatically. To illustrate this point, FIG. 2 provides the steps involved in the log on of a teller to a banking application. In this example, whenever a dialog (i.e., a box or window displayed by the application to solicit a response) titled “Log On to TellerSys” appears, the user must enter user name and password.

Referring to FIG. 2, a teller initiates or starts a banking application 26. The present system then attempts to match a template to a banking application window name 28 (or uses one of the other methodologies discussed). If no match is found the system pauses 30 and goes back to the start 26. If a name match is made, the system determines if the application has the right fields for a banking application 32. If not, the system again pauses 30 and goes back to the start 26. If the right fields are found, the system obtains the user's biometric identifier (e.g., fingerprint) or other identifying credentials 34 with a biometric scanning device (e.g., fingerprint scanner) connected to the teller's computer. Based on the biometric identifier, the system then locates the user name and password for the user for the banking application in a database 36, and injects the username and password in the banking application window 38.

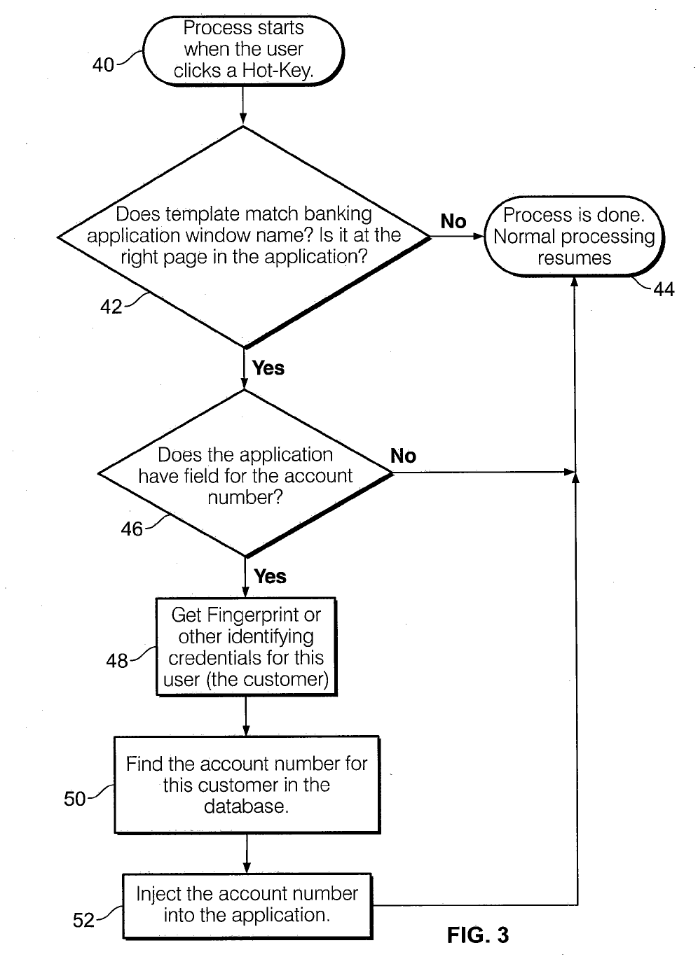

In another example, the flowchart of FIG. 3 illustrates how the same banking application can be used to identify customers. In this embodiment, the original banking application requires the teller to enter the user's account number into a text box. The process is initiated or started by creating a template, which uses hotkey F12, to enter the account number from the database into the account number field 40. The system then determines if the template matches the banking application window name and if the window is at the right page in the application 42. If the window is not on the correct page the system will not run the template and normal processing resumes 44. If the template name and page match, the system determines if the application has a field for the account number 46. If the application has the field, the system obtains a biometric identifier or other identifying credentials of the customer 48, and then locates an account number for the customer in the database 50. The system then injects the account number into the application 52.

Most applications have some user process where the user can change their password utilizing a dialog (sometimes referred to as a ‘dialog box’). These dialogs usually require the user to type in their user name, old password, and new password. The present system can create a template for this type of dialog that uses the standard matching, and inserts the user name and old password in the same manner. Additionally, the template can be configured to obtain a new password and fill this in to the new password field or fields (e.g., some applications require it to be entered twice for confirmation). Doing this allows the password to be changed in the application and also in the database where the system stores the passwords. It also allows the automatic synchronization of the password between the two or more databases.

In some instances, an application will often display a dialog that tells the user their password is about to expire. The present system can automatically recognize this dialog using the techniques discussed herein. The system can set up a template so that when the application prompts the user to change their password, the system automatically takes over and goes through the whole process for the user. In this way, the user never even needs to know what their password is.

In some cases, the user may not directly change their password. Instead, the System Administrator may change the password and issue the new password to the user. The present system supports this mode of operation. However, when the System Administrator generates the new passwords, instead of passing them to the users, the passwords can be imported directly into the system database. The system can also automatically generate new passwords in its database and export them so that the System Administrator can import the passwords directly into an application.

Finally, if there is a suitable template created, the system can be set up on a computer running the standard (e.g., teller) application and automatically (overnight perhaps) log on as each user in turn to the application, change the password automatically (causing the password to change both in the system database and the application database), and thus in bulk change all of the passwords. Using this method, it is possible to configure a system where the passwords are changed every day and strong passwords are used every time. This provides strong security and extreme convenience for the users.

In accordance with another embodiment of the invention, when the system generates the passwords, a template can specify two different options: either the user can type in a new password or the system can automatically generate a random password for the user. The second option is more secure, but sometimes it is necessary for the user to actually know their password, which can be accomplished with the first option. The option offered to the user can be set on a per user basis. For example, a System Administrator may need to know their password, and when generating a new password, the System Administrator will type one in. However, a basic user would not need to know their password, so the system would automatically generate a random password for them. When automatically generating a password, the user never knows what it is and must use the system to automatically insert it.

A template can be configured to automatically require the user to change their password at configurable intervals. This would prompt the user to make the change at the appropriate times. Additionally, a background process can be run which executes a series of templates without user intervention. These templates log a user on, change and randomize the password, and log them off, by running a sequence of templates in turn. These may be executed for everyone in an organization, or a select group. This allows, overnight—for example, passwords to be changed at an interval specified by the configuration.

A template may specify criteria for a password, (e.g., maximum and minimum lengths, lower case, upper case, digits, punctuation, etc.). A random password is generated by the template within these criteria, allowing the system to meet any such requirements imposed by the application. Outside of these constraints, the system uses a strong pseudo-random number generator to create very strong passwords. In some implementations, the system can use a true randomly generated number (using fingerprint image data as an arbitrary data source) to give a true (not pseudo) random number that is used to generate very random passwords. Of course the true random data is appropriately conditioned and randomized before use.

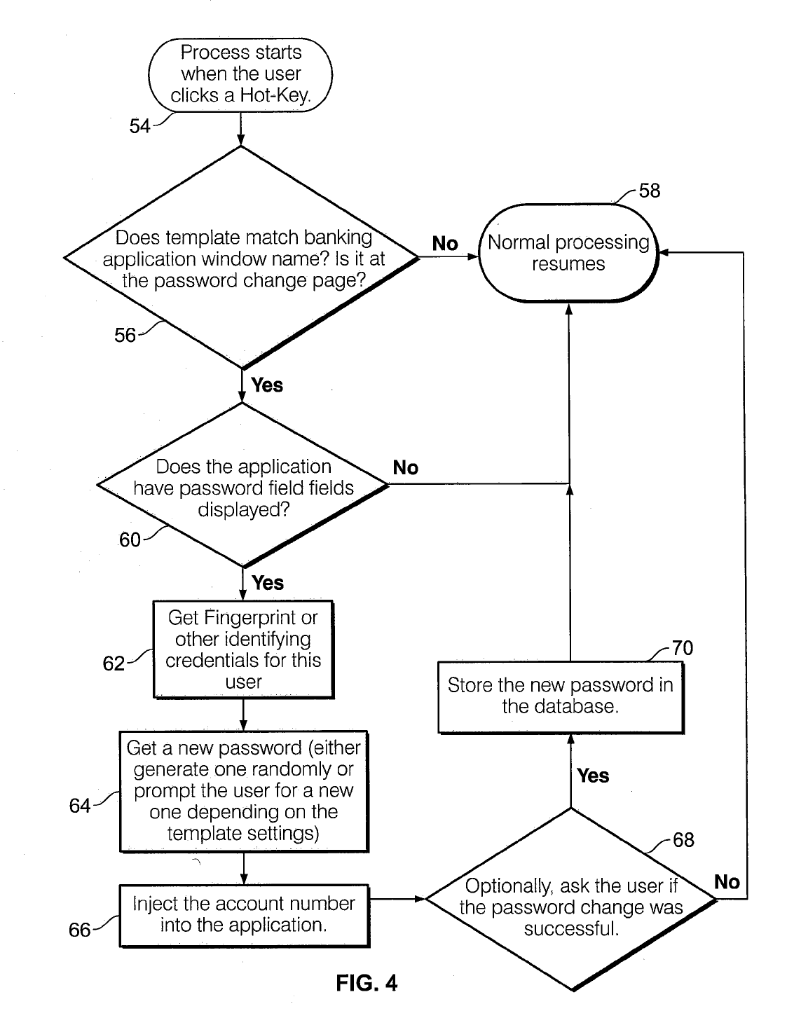

FIG. 4 illustrates an example of changing a password for a banking application. After the banking application is started 54, the system determines if a template matches the banking application window name, and whether the window is at the password change page of the application 56. If not, normal processing is resumed 58. If the template matches, the system then determines if the application has password change fields displayed 60. Again, if not, normal processing is resumed 58.

If the application does have the password change fields displayed, the system obtains a biometric identifier (e.g., a fingerprint) of the user (i.e., banking customer) 62. The system then proceeds to obtain a new password 64—either by randomly generating one or by prompting the user to insert one, depending on the template settings. The system then injects the old password, new password and any other required data into the fields of the password change window of the application 66.

The system can optionally be configured to ask the user if the password change was successful 68. If not, the system can resume normal processing 58. However, if successful, the system stores the new password in the database as associated with the biometric identifier of the user 70.

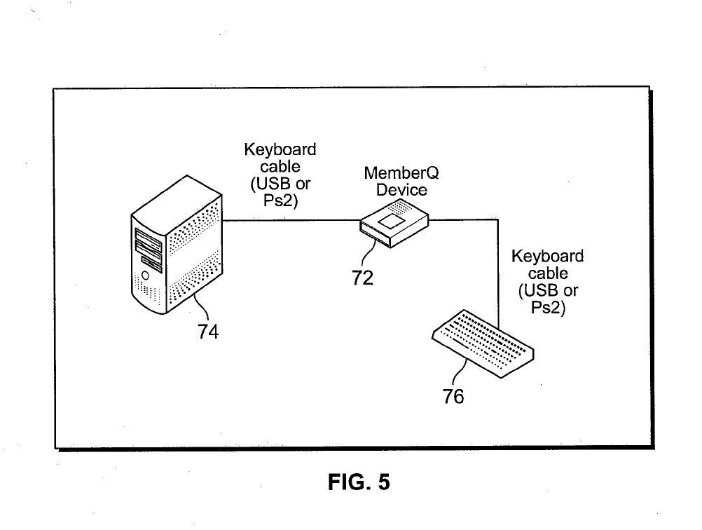

As illustrated in FIG. 5, the system can be incorporated in an external device 72 that can be inserted between the user's keyboard 74 and local computer or server 76. The device 72 allows the use of the present system described herein in situations where the system cannot be run on a host computer due to operating system restrictions or limited functionality of the computer (e.g., a dumb terminal). In this configuration, the external device 72 runs the template. The device 72 does this by inserting simulated characters directly into the keyboard port of the computer 76. This is preferably only done using copy me templates. The device 72 works as a “keyboard wedge” for many different types of keyboard connections, including PS/2 and USB. Additionally, the present system can also be used in a special mode of simulated typing. In this mode, the biometric identifier (e.g., fingerprint) is captured on the external device 72. When the person is identified, the appropriate template is played.

Generally, the device 72 is configured to run one template. However, template selection is also possible via a menu on the device 72. The device 72 can also operate in a hotkey mode, where a hotkey from the keyboard is trapped in the device to activate the template. The hotkey can be passed on to the computer at the discretion of the template encoding. The device 72 can also capture a PIN number or keyboard input for dual factor identification.

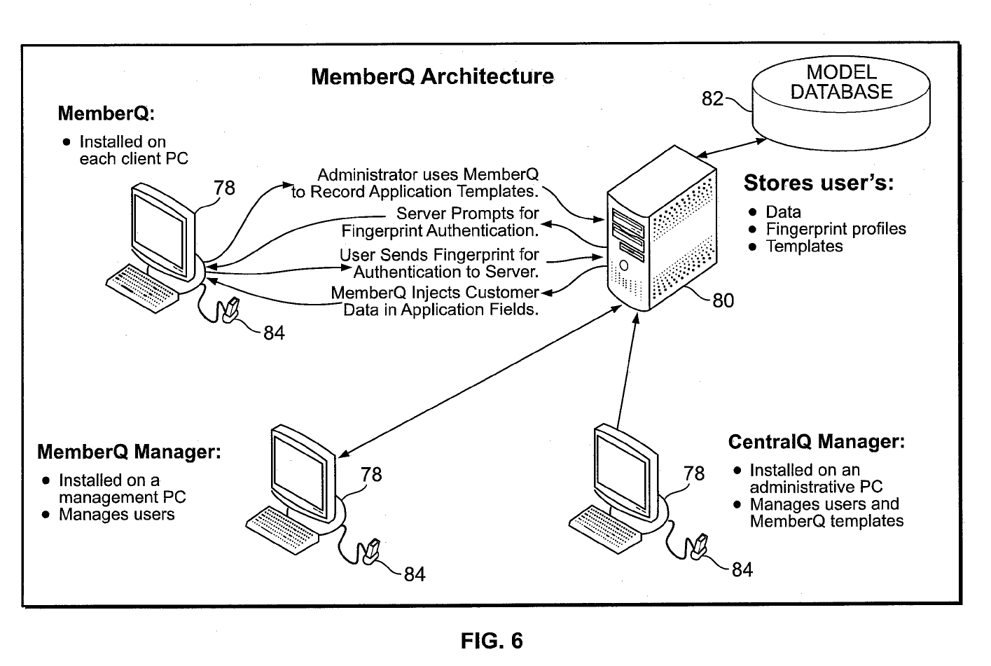

Alternatively, the system can be loaded onto one or more personal computers 78 and/or a central server 80 via a network connection as shown in FIG. 6. The central server 80 can be coupled to a database 82 containing the stored biometric identifiers and user information, as well as the templates. Each of the personal computers 78 can be coupled to a fingerprint scanner 84 or other biometric input device.

The present system requires a properly defined template or set of templates to operate correctly. To facilitate obtaining such templates, a recording system can be provided that helps the user or System Administrator to create useful templates quickly and easily. Preferably, the template creation process is restricted to a select group of users in an enterprise or organization, and executing the templates is controlled using standard access control systems.

There are a variety of template recording methodologies, from simple to complex that can be utilized in the present invention. The simplest methodologies are the easiest to use, but have a limited range of applications with which they will work. The more complex recording methodologies are harder to use, but work with a broader range of applications. By offering a spectrum of methodologies, the present system allows the user to easily record simple templates, without restricting them from dealing with more complex applications, which, admittedly, require more work during the template recording phase.

The simplest recording strategy is the use of idiom templates. Idioms are common arrangements of dialogs that are used in many different applications. For example, a logon dialog often has a clear text dialog box, a password box, and an OK button. This would be a typical idiom. The present system is configured to automatically recognize many of these idioms, and upon recognition, create an appropriate template automatically, asking only what data fields in the database should be used. Once an idiom has been used to generate a template, that template makes no future reference to its source idiom. Idioms are concepts built into the system and are not stored in the database. One such idiom is a password change idiom, which, when recognized, will automatically generate a suitable password change template. Idiom templates are generated once at the first recording and are saved as any other template for the purposes of subsequent editing.

An alternative method is a field selection recording. In this method, the user brings up a template recording wizard when the logon dialog displays in the application. The system presents the user with a list of the control fields that it can see in the dialog. Clicking the field highlights that control in the underlying application. Also, the user can directly select a control by direct manipulation or by dragging a field chooser control onto the field. These fields are then mapped to the database fields used to fill them in. This method suggests title matching as the preferred matching methodology. It also allows the user to edit the template to provide more detailed matching criteria and set various options on how the text is entered into the fields. Additionally, the user may also select this template to be a password change template.

Another alternative is a Copy Me template recording. When recording a Copy Me template, the system is set to watch how the user logs on to the application. It records each of the actions the user performs, such as clicking windows, typing text, clicking the tab key, etc. These actions are converted into a suitable set of commands for the Copy Me template.

Once the user's raw actions are recorded, the Copy Me template is converted into a more convenient form. What this means is that the various text strings that the user typed in are converted from single characters into strings of characters. Additionally, if any strings of characters are the same as any of the system database field values for this user, they are converted from straight text fields into insert commands of that field's value instead. By default, a Copy Me template is displayed in simple mode. The user may edit the template in simple mode, or if more detailed editing is required, the user may switch to advanced mode. The user may freely switch between the two modes and may edit the template in either mode.

The present system also provides a dynamic code facility that works with applications that behave in an unusual manner (e.g., an application that does not follow a design based on Microsoft's best practices or an application that purposely makes it difficult to work with other systems or applications). The purpose of dynamic code is to allow the integrator of the system to write a small piece of computer software code, which works within the framework of all the other parts of the system and provides for any small functions that are not otherwise available in the rest of the system. This can be used both for matching and filling in fields. The dynamic code system operates within the existing framework and is not meant to perform all parts of the operation. Instead, it is meant to fill in the gaps of what the rest of the system cannot do. Dynamic coding can require substantially more work than other types of template definition, however it can be used to provide a complete system.

An example of a use for dynamic code is a situation where a template is needed for a non-standard application. For example, most web mail applications (such as hotmail, Gmail, Yahoo mail, etc.) are all very similar, and a standard template can be created to handle these applications. However, if a new web mail application comes along which requires additional information not required by the prior web mail applications (e.g., a PIN number entered via mouse clicks on a PIN pad on the new applications web page—moreover, the PIN pad number order may change each time the page is refreshed), then a different type of template is needed. Dynamic code can be implemented to create a template to handle such an application.

In particular, dynamic code can be written for a listener. A dynamic listener watches the activity of the operating system to identify places where the present system can operate. This may be required for applications that do not follow the standard “Win32” methods or operations, where dynamic code can then be utilized in the creation of custom scripts that can use very specific criteria for matching.

Dynamic code can also be written for matching and injection functions of the system. Once a window has been found by the system, each template can have dynamic matching scripts that can be used to verify that a given template matches a given window. This is useful in places where the login or password change dialogs have all the same normal matching information (such as the same URL) as other non-intended dialogs. Additionally, once a match has been found and the user identified, each template can have dynamic injection scripts that can be used to perform special functions. For example, if an application required the user to press “Ctrl+Alt+Delete” to login, a dynamic injection script can be created that performs that special key-press. It can also be used if an application had a special API for logging in other than the normal UI method.

The system also allows a user to export one or more templates into an external format. This includes both the template and the data fields required by the template. These templates may subsequently be imported into another system. This allows for easy sharing of templates.

The system also allows for collaboration with other users through a public discussion forum. This allows for tips and tricks along with sharing exported templates directly and with a searchable archive.

Once a template is created, it may be edited using an editor tool. Each of the different components of the template can be edited independently. For example, the template can be edited to change general information such as the template's name and description, or whether a user must supply a PIN number. Additionally, matching criteria may be edited. This includes adjusting whether the template should or should not match on an executable name, dialog title and parent title. The editing tool also allows for changing the values of the executable name and titles, and how to match against the name and titles. Other editable criteria include turning on or off automatic execution, matching on reactivation, hotkey matching or dynamic code matching.

The injection criteria that can be edited include a direct injection or copy me injection properties. The editing tool allows for altering all of the information for creating a direct or copy me injection template.

For many industries it is necessary to have two separate identifying criteria (dual authentication). This might be a fingerprint and PIN code, or another type of biometric such as an iris scan, a palm print, a retinal scan, a hand geometry scan and so forth. Alternatively, a token such as a card, or RFID token might be used. Finally, a piece of knowledge, such as a password, pin code or question and answer can be used to further enhance security. These identifying criteria are stored in a central database and used to identify the person.

During matching, it is possible that several templates may match a window. When this occurs, a list of the matching templates displays during the identification, (i.e., the fingerprint scanning phase). The user may select the template to run. A template may be marked as the default in which case that will be shown as the default template.

Additionally, a user may have several personae assigned to them. That is, one individual person may play several roles within an enterprise. For example, a teller supervisor might be an Administrator or a teller. During fingerprinting, one persona is the default, but the user may also select a different persona, meaning a different set of system data fields are used. Personae can be selected either by selecting from a list, or, when there are multiple identification criteria, which one is selected can be used to determine which persona is used. For example, a bank teller might use their left index fingerprint to log on as a regular teller, and their right index fingerprint to log on as a supervisor. Similar variations in PIN code or other identifying criteria (listed above) can be used to automatically select a default persona.

In addition to the ability to share data such as usernames and passwords, the system also has the capability to perform one (or some small number) of shares. In this situation, the owner of the credential allows a delegate to use the credential one or more times. This allows, for example, a secretary to use a manager's credit card one time. The data is obscured, and controlled by a template, so that the secretary cannot reuse that card again (without another explicit authorization.) This is also useful in allowing one time access via password to other systems, and many other such applications. The limitation imposed can either be a limited number of uses of the credential, or access to the credential for a limited amount of time, or a combination of both.

The present system, because of its capability to log on to applications automatically using templates, can consolidate data from multiple applications into one. To do that, a consolidation template is specified. This type of template lets the system know which applications to run and which templates to use for that application (including the automatic handling of password changes). The applications run and then the consolidation template describes how to get to the appropriate part of the application (using a standard template). Then a copy of all or part of the application screen can be captured. These screen captures can be tessellated into a consolidation view, which shows the screens from several applications in one single window. The user may select one of these views and interact with it directly with mouse clicks and keyboard input. This input is translated directly to the underlying application.

When a consolidation template is run, the user is identified and that identification is used to log on to all the other applications. The data is then presented to the user in a consolidated form. It is possible in a consolidated application to have multiple logons for different parts of the application.

An example of a consolidation template would be for a medical application. A doctor would log on as one user, which would grant him access to various medical databases and patient records. The doctor might log on to the prescription system, the diagnostic AI system, the patient's record system, the X-Ray recording system, and the patients health chart application. One log on would allow the doctor to log on to all these systems and the appropriate parts of the application would be tessellated into one consolidated view. A second log on for the patients would allow the doctor to view that patient's record by biometrically identifying the patient in all the systems. This consolidation system is broadly applicable in many different areas of business both inside and outside the medical industry.

The present system includes a watcher application. The watcher application is a process that runs in the background. At regular intervals, the watcher application polls the screen to see if any new windows have displayed (or if using a multiple retry template, if it needs to be retried). If there is a change to the set of windows, the templates are examined to see if there is a match, and if so, the template is executed. The watcher application also looks at Web browsers to see if the page has changed, and if so, if a template matches.

The watcher application runs constantly, but is designed to adjust its frequency of operation so that the user may specify how much time it takes up on the host PC. This can be tuned down so that it is imperceptible to the user. This tuning allows the user to trade off between excessive resource usage verses responsiveness.

A goal of one aspect of the present system is to eliminate knowledge of the identifier, password, user name, etc. The system does this by managing the data independently of the application and automatically typing it in to the application based on biometric identification. With passwords, this is usually pretty straightforward, since most applications already obscure the password when it is typed in by using asterisks instead of the actual characters of the password. This is frequently not true of other items that may be entered, (e.g., credit card numbers, user names, patient identifiers, and social security numbers). To deal with this problem, the system has an obscuring feature. When an obscuring template matches, a blank window is placed over the location of the field to be obscured. This feature can work in concert with a regular template (where data is entered), but can also work with application screens where data appears later, even if the system is not required to actually enter any data into that field. Additionally, a data element in the system database can be specified as obscure only or password only. If it is obscure only, then the data is permitted to be used only when the field is obscured. If it is password only, the data may be entered into a control only with a property indicating that it is a password field (and hence the data is obscured with asterisks).

In the present system matching on a text-based device (i.e., a type of application that does not use a conventional GUI-based interface, e.g., a DOS terminal, a Telnet session, a mainframe session) is largely the same as a standard match using text matching, etc. However, there is one additional matching criterion. That is, a regular expression can be specified which is frequently matched against the text in the screen itself. This is useful so that an interaction like the following can be matched:

Logon Name: John.Smith

Password: *****

Here, before the template is executed, the system must wait for the text “Logon Name:” This is a typical type of match of this nature.

During execution, a new command is added for advanced templates. This command is ‘Expect Text.’ The Expect Text command takes a regular expression. When this command is executed, the execution is paused until text matching the regular expression is seen on the screen. In the previous example, before inserting the password, the command Expect Text “Password:” would be inserted. This would pause the execution of inserting the password until the text-based application prompted the user for it.

Template chaining is a technique that allows several templates to execute in a row. This works by allowing a template to use “stale” credentials. Normally, when a template executes, it prompts for a biometric identifier (e.g., fingerprint) and other credentials. With template chaining, a template may reuse a recently acquired set of credentials. So for example, if a log on process involves two independent logon boxes, templates are recorded for both. Normally, the user would have to supply their biometric identifier twice, once for each template. However, if the second credential is allowed to use stale credentials, the system will not prompt for the second credential when it is time to execute; it will simply reuse the credentials from the first template.

To specify template chaining, a user need only set the second or subsequent template to allow stale credentials and the maximum age (in seconds) of the credentials. Note that we do not specify the chain explicitly; the normal matching mechanisms are used for this. This allows for some complex networks of templates to be defined in a fairly simple manner. For example, in the two logon scenario described above, after the first logon, the user might be prompted to change their password. If a template is specified for this along with template chaining, then the first logon dialog collects credentials, the password change dialog display and reuses the credentials, the system generates a new password and redisplays the second logon dialog, which then (once again) reuses the stale credentials and logs on. By simply specifying three independent templates, many complex variations of template chaining happen automatically.

In addition to regular enterprise wide templates, it is possible for users to specify their own personal templates and template data. This allows the system to automate the management of user names, passwords and so forth for the user's own applications and web sites.

Security policies often require dual authentication, which means that two different credentials are required to identify the user. Traditional security systems use three classes of identification: what you are, what you know, and what you have. Biometrics, such as a fingerprint, provide authentication on the basis of “what you are.” The present system and method allows secondary identification by other types of identifiers such as: PIN codes; secondary biometric identifiers; secure tokens, passwords, and proximity and other identification cards.

The present system and method is designed to work with user names and passwords. However, this is by no means the only application of this technology. The system and method also allows the automatic insertion of any type of data (one or more fields) based on identification of a user. For example, the system or method might be applied to insert: a membership number (when a member purchases/rents an item); patient identifier (in a hospital or clinic), a credit card number in a web site (possibly along with a billing address, expiration date, etc.). The system and method can be employed in other applications where data needs to be protected by biometrics, and must be typed into an existing application.

The present system and method is preferably designed to work with an access administration system. In this instance, the databases maintained by the access administration system may be utilized by or shared with the present system for any of the functions requiring data from a database.

While the specific embodiments have been illustrated and described, numerous modifications come to mind without significantly departing from the spirit of the invention, and the scope of protection is only limited by the scope of the accompanying Claims.

What is claimed is:

1. A method for adding biometric identification security to an application comprising the steps of:
running a first application lacking biometric identification from a computer coupled to a biometric device by a user;
providing a template configured to monitor the first application;
recognizing a logon screen of the first application by the template, the logon screen including at least one field requiring insertion of user information;
prompting the user to input a biometric identifier using the biometric device;
comparing the inputted biometric identifier with a plurality of biometric identifiers maintained in a database of users authorized to access to the first application, the database include logon information for the authorized users;
matching the inputted biometric identifier of the user with one of the plurality of biometric identifiers in the database; and,
inserting the logon information of the user from the database into the at least one field of the logon screen using the template.

2. The method of claim 1 wherein prompting the user to input a biometric identifier using the biometric device comprises obtaining a fingerprint scan of the user's finger.

3. The method of claim 1 wherein the step of inserting the logon information of the user from the database using the template comprises inserting a password associated with the user.

4. The method of claim 1 wherein the step of inserting the logon information of the user from the database using the template comprises inserting a username associated with the user.

5. The method of claim 1 wherein the step of inserting the logon information of the user from the database using the template comprises simulating typing the logon information to the application by sending a sequence of keystrokes.

6. The method of claim 1 wherein the step of recognizing a logon screen of the first application by the template comprises the step of matching a name of a logon window appearing in the application.

7. The method of claim 1 wherein the step of recognizing a logon screen of the first application by the template comprises the step of matching a logon field appearing in the application.

8. The method of claim 1 wherein the step running a first application lacking biometric identification from a computer coupled to a biometric device by a user comprises the step of logging onto an application website over the Internet.

9. The method of claim 8 wherein the step of recognizing a logon screen of the first application by the template comprises matching an uniform resource locator address of the logon screen of the application.

10. The method of claim 1 further comprising the steps of:
requiring the user to change the user's password by the first application; and,
obtaining a new password for the user utilizing the template.

11. The method of claim 10 wherein the step of obtaining a new password for the user utilizing the template comprises the steps of prompting the user for a new password and importing a new password received from the user into the database.

12. The method of claim 10 wherein the step of obtaining a new password for the user utilizing the template comprises the template automatically generating a new password associated with the user, and importing the new password into the database.

13. The method of claim 12 further comprising the steps of:
providing criteria for a password by the first application; and,
configuring the template to meet the criteria when generating a new password.

14. A system including additional biometric identification security for granting a user access to an application lacking biometric identification capability comprising:
a server configured to run a first application lacking biometric identification capability, the server further configured to run a template configured to monitor the first application and obtain a biometric identifier of a user upon identifying a window in the first application requiring the insertion of logon information, the template in communication with a database of biometric identifiers of a plurality of authorized users of the application, the database including logon information for each authorized user, the template configured to insert logon information of the user into the logon window upon matching the user's biometric identifier with one of the biometric identifiers stored in the database; and,
a biometric device coupled to the server for obtaining a biometric identifier of the user.

15. The system of claim 14 wherein the biometric device is a fingerprint scanner.

16. The system of claim 14 wherein the template is configured to utilize a matching methodology to determine when the first application is displaying the window requiring insertion of logon information.

17. The system of claim 16 wherein the template is configured to match a name of the window requiring insertion of logon information.

18. The system of claim 16 wherein the template is configured to match a field of the window requiring insertion of logon information.

19. The system of claim 14 wherein the template is configured to input the user's password in the window requiring insertion of logon information.

20. The system of claim 19 wherein the template is configured to change the user's password to meet a requirement of the application, and associate the changed password with the user's logon information stored in the database.
